(19) United States
(12) Patent Application Publication
(10) Pub. No.: US 2002/0142676 A1
(43) Pub. Date: Oct. 3, 2002

(54) Electric connector for twisted pair cable using resin solder and a method of connecting electric wire to the electric connector

(75) Inventors: Taiji Hosaka, Yokohama-shi (JP); Masaaki Miyazawa, Kawasaki-shi (JP)

Correspondence Address: FASSE PATENT ATTORNEYS, P.A., P.O. BOX 726, HAMPDEN, ME, 04444-0726, US

(73) Assignee: J. S. T. Mfg. Co., Ltd., Osaka (JP)

(21) Appl. No.: 10/114,197

(22) Filed: Apr. 1, 2002

(30) Foreign Application Priority Data
Mar. 30, 2001 (JP) 2001-102646

(51) Int. Cl. H01R 4/02

(52) U.S. Cl. 439/874

(57) ABSTRACT

The objectives of the present invention include to connect a twisted pair cable to the electric connector without undoing the twist of the end of the twisted pair cable, to accurately keep the twist of the twisted pair cable up to the end thereof, to make the twisted pair cable fully exhibit its noise cancellation effect, and to maximize impedance matching.

The electric connector for twisted pair cable using resin solder according to the present invention comprises a pair of electric contacts having the first connecting part, which fits with the counterpart connector, and the second connecting part, to which the conductor of the electric wire is connected, and an insulating member, which insulates and holds these electric contacts. In each of the electric contacts, at least a part of the second connecting part, to which the conductor of the electric wire is connected, is made of a lead-free ultrahigh-conductive plastic being a conductive resin composite.

### BACKGROUND OF THE INVENTION

1. Field of the Invention

The present invention belongs to a field of electric connectors to which a twisted pair cable is connected, and relates to an electric connector comprising electric contacts, which use a lead-free ultrahigh-conductive plastic being a conductive resin composite.

2. Related Art

A twisted pair cable, which comprises two electric wires being twisted together, is known as signal lines for transmitting electric signals. The twisted pair cable has a merit that it is hardly influenced by noises generated by external induction coupling because even if noise currents are generated by external magnetic fluxes in the twisted pair cable, the noise currents will be cancelled out. The twisted pair cable also has merits that due to this noise signal cancellation effect, signals in a twisted pair cable are hardly influenced by signals in another twisted pair cable and that the crosstalk is improved in comparison with conventional straight cables.

When this twisted pair cable is to be connected to an electric connector, coverings at one end of the twisted pair cable will be removed to expose the conductors and these conductors will be connected to electric contacts by soldering, crimping or insulation displacement contact. In any form of connection, to secure an addequate working space for connecting the conductors to the electric contacts by soldering, etc., the twist at the end of the twisted pair cable will be undone before connecting the conductors to the electric contacts by soldering or the like. After the connection by soldering or the like, the end of the twisted pair cable, which has been connected to the electric contacts, will be retwisted and inserted into the housing of the electric connector. However, it is difficult to recover the exact twist by retwisting, and if the twist is not accurate, the noise signal cancellation effect will be impaired and, in turn, the impedance matching will be affected. Moreover, the work of undoing the twist of the end of the twisted pair cable and then retwisting the end thereof is troublesome.

When an electric wire is to be soldered to an electric contact, the conductor of the electric wire is placed on the electric contact, then molten solder is applied. However, if the electric wire is to be soldered to, for example, a recess in the electric contact, it is difficult or impossible to do so. Furthermore, this work of applying solder requires delicate quality control, temperature control and the like of the solder, and the control man-hour increases correspondingly.

When the electric wire is a very fine wire (for example, American Wire Gauge size 36 falls in the category of very fine wire, and the diameter of this electric wire is 0.12 mm approximately.), the work of applying molten solder to the contacting parts of both the conductor of the electric wire and the electric contact can not be done by an automatic machine, and it is inevitable to do the work manually by a skilled worker. Hence the productivity is low and this results in an increase in cost. A similar problem will be encountered when a very fine wire is to be connected to the electric contact by crimping or insulation displacement contact.

Japanese Patent unexamined publication gazette Heisei 10-237331 discloses a lead-free ultrahigh-conductive plastic being a conductive resin composite, comprising a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal.

### SUMMARY OF THE INVENTION

This lead-free ultrahigh-conductive plastic exhibits high conductivity, for example, 10⁻³ Ω·cm or under in volume resistivity. Moreover, this material can be formed by injection molding and has a high degree of formability. As this material contains solder, there is no need of separately applying solder. One objective of the present invention is to provide an electric connector and a method of connecting electric wire to this electric connector, which can solve the above-mentioned problems, by using the lead-free ultrahigh-conductive plastic that has such excellent conductivity and formability and contains solder.

To accomplish the above-mentioned objective, an electric connector for twisted pair cable using resin solder according to the present invention comprises a pair of electric contacts having a first connecting part, which fits with a counterpart connector, and a second connecting part, to which a conductor of an electric wire is connected, and an insulating member, which insulates and holds these electric contacts, and in each of the electric contacts, at least a part of the second connecting part, to which the conductor of the electric wire is connected, is made of a lead-free ultrahigh-conductive plastic being a conductive resin composite, comprising a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal.

The coverings at the end of the twisted pair cable are removed to expose the conductors, and these conductors are placed on the parts of the second connecting parts of the electric contacts, to which the conductors of the electric wires are connected. When the contacting parts of both the conductors and the electric contacts are heated, the lead-free solder being contained in the lead-free ultrahigh-conductive plastic of these parts will melt out to stick to the conductors of the electric wires. When the solder cools and solidifies, the conductors of the electric wires will be connected to the electric contacts. This work can be done without undoing the twist of the end of the twisted pair cable. Hence the twist of the twisted pair cable can be maintained correctly up to the end thereof, and the noise signal cancellation effect will be fully exhibited and the impedance matching will be maximized. Moreover, as the work of undoing the twist of the end of the twisted pair cable and retwisting the end thereof is not required, the connecting work can be done easily. Further, the work of separately applying solder is not required. Hence the electric wire can be easily connected to a part which is difficult or impossible to solder, for example, a recess in the electric contact. As solder quality control, temperature control and the like are not required, the control man-hour is reduced correspondingly. Further, connection of a very fine wire can be done by an automatic machine, and the productivity is enhanced and the cost is reduced. The lead-free ultrahigh-conductive plastic exhibits high conductivity, as high as 10⁻³ Ω·cm or under in volume resistivity. Hence the electric resistance of the electric contact can be reduced. After the connection of the electric wires, when electricity is passed at a normal level, the lead-free ultrahigh-conductive plastic will not melt due to heat generation. Moreover, in comparison with the technology of MID (Molded Interconnection Device; for example, refer to Utility Model Gazette No. 2597015) wherein a conductive plated layer is formed on the surface of an insulator, the lead-free ultrahigh-conductive plastic provides the conductor with a larger cross-sectional area and a larger volume. Hence the resistance of the conductor can be reduced and the heat dissipation is better. This in turn allows passage of a larger current. As the lead-free ultrahigh-conductive plastic can be formed by injection molding, it has a greater freedom of molding, and parts which are made of the lead-free ultrahigh-conductive plastic can be molded into a variety of configurations according to the applications. This makes it easier to obtain impedance matching. When only some parts of the electric contacts are made of the lead-free ultrahigh-conductive plastic, if other parts are made of a material of which strength and elasticity are higher than those of the lead-free ultrahigh-conductive plastic, for example, a metal, the strength and elasticity of the electric contacts, in particular, the strength and elasticity of the first connecting parts will be enhanced.

### BRIEF DESCRIPTION OF THE DRAWINGS

FIG. 1 is a perspective view of the electric connector of the first embodiment according to the present invention.

FIG. 2 is a sectional view of the electric connector of the first embodiment cut along a groove.

FIG. 3 is a sectional view of the electric connector of the first embodiment cut along a plane which is perpendicular to the grooves.

FIG. 4 is a perspective view of the electric connector of the first embodiment, to which electric wires are connected.

FIG. 5 is a schematic diagram showing another embodiment of the method of connecting electric wires to the electric connector of the first embodiment.

FIG. 6 is a perspective view of the electric connector of the second embodiment.

FIG. 7 is a perspective view of the electric connector of the third embodiment.

FIG. 8 is a perspective view of the electric connector of the fourth embodiment.

FIG. 9 is a perspective view of the electric connector of the fifth embodiment.

FIG. 10 is a perspective view of the electric connector of the sixth embodiment, to which electric wires are connected.

FIG. 11 is a schematic structural diagram of the lead-free ultrahigh-conductive plastic used in the embodiments.

FIG. 12 is a schematic structural diagram of the conventional plastic wherein powder of a metal that does not melt is kneaded in a resin.

### DESCRIPTION OF PREFERRED EMBODIMENTS OF THE INVENTION

In the following, some embodiments of the electric connector for twisted pair cable using resin solder and the method of connecting electric wires to this electric connector according to the present invention will be described.

First, the above-mentioned lead-free ultrahigh-conductive plastic, which is commonly used in all the embodiments of the present invention, will be described in detail according to the description of Japanese Patent unexamined publication gazette Heisei 10-237331. This lead-free ultrahigh-conductive plastic is a conductive resin composite, which comprises a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal. This lead-free ultrahigh-conductive plastic includes those wherein lead-free solder parts that are finely dispersed in the above-mentioned thermoplastic resin are continuously connected to each other in the entire resin. The above-mentioned lead-free ultrahigh-conductive plastic includes those of which above-mentioned conductive resin composite has such a conductivity that the volume resistivity thereof is as low as 10⁻³ Ω·cm or under.

The synthetic resin to be used for this lead-free ultrahigh-conductive plastic is not specifically limited, and those that have been used conventionally can be used. However, from the viewpoints of ease in molding and some other physical properties required, it is preferable to use a thermoplastic resin.

The metal to be used for this lead-free ultrahigh-conductive plastic must be a lead-free metal that can half melt when the synthetic resin composite containing the metal is heat-plasticated. As the heat plastication temperature of thermoplastic resin is normally 350° C. or under, low-melting-point metals having a melting point below the above-mentioned plastication temperature are preferable. The metal may be a pure metal or an alloy. As the metal is kneaded under half-melted condition, its configuration is not limited particularly. However, a granular form or a powdery form of metal is preferable since it is easy to handle for dispersion.

Specific examples of the above-mentioned metal include zinc (Zn), tin (Sn), bismuth (Bi), aluminum (Al), cadmium (Cd), indium (In) and their alloys. Examples of preferred alloys among them include low-melting-point alloys such as Sn—Cu, Sn—Zn, Sn—Al and Sn—Ag.

Metals in powdery form for assisting dispersion of the solder include copper (Cu), nickel (Ni), aluminum (Al), chromium (Cr) and their alloys all in powdery form. The finer is the particle diameter of the metal powder, the finer is the dispersion of the solder after kneading. However, it is not necessary to provide powder of a common particle diameter. Powder of a metal having a distribution of particle diameters can be used. The usage of the metal components in the above-mentioned lead-free ultrahigh-conductive plastic is from 30 to 75% and preferably from 45 to 65% in volume ratio to the entire conductive resin composite.

The above-mentioned lead-free ultrahigh-conductive plastic uses a resin and a low-melting-point alloy (lead-free solder) which does not contain lead from the viewpoint of environment. As they are kneaded when the metal is kept in a half-melted state, the lead-free solder being metal components can be dispersed finely throughout the resin. Moreover, as kneading is made when the lead-free solder is kept under a half-melted condition, the dispersed solder fractions are kept connected continuously to each other. This connection is not just a contact but a junction between solder fractions. As the conductivity thus achieved differs from that obtained by contacts among metal fractions, even if the molding is heated to a high temperature, the junctions will not break, thus the molding stably exhibits low resistance.

When this material is to be formed by injection molding, as the metal components are partly half-melted and the lead-free solder is finely dispersed, the material can be formed by injection molding into fine configurations although the material contains a large amount of metal components. Hence electric contacts and the like can be formed by processes of injection molding alone. Moreover, as no plating is required, a conductive part of low resistance can be formed inside the injection molding.

To produce the above-mentioned conductive resin composite, kneading machines and extruding machines for conventional resins can be used.

Next, embodiments of the above-mentioned lead-free ultrahigh-conductive plastic will be described.

Embodiment 1

45% by volume of ABS resin (produced by Toray; Toyolac 441), 40% by volume of lead-free solder (produced by Fukuda Kinzoku Hakufun Kogyo; Sn—Cu—Ni—AtW-150) and 15% by volume of copper powder (produced by Fukuda Kinzoku Hakufun Kogyo; FCC-SP-77, mean particle diameter 10 μm) were lightly mixed together and fed into a kneader (Moriyama Seisakusho make, double-screw pressurized type) which was set at 220° C. The mixture was kneaded, without preheating time, at a rate ranging from 25 to 50 r.p.m. for 20 minutes; the resin was heat-plasticated and the solder, under half-melted condition, was dispersed throughout the resin.

The kneaded material was pelletized by a plunger extrusion pelletizer (Toshin make, Model TP60-2) at the dies temperature ranging from 200 to 240° C. to produce pellets. These pellets were used to make injection molding into molds by an injection molding machine (Kawaguchi Tekko make, KS-10B). The preset temperature was from 230 to 280° C., and the mold temperature was from the ordinary temperature to 150° C. The injection moldings obtained showed no sign of segregation of metal, and their surfaces were even.

Observation, under an optical microscope, of the state of dispersion of the solder of this injection molding showed that the solder was evenly dispersed throughout the resin and solder fractions were about 5 μm in size. The volume resistivity of this specimen was on the order of 10⁻⁵ Ω·cm.

Embodiment 2

45% by volume of PBT resin (produced by Polyplastic), 40% by volume of lead-free solder (produced by Fukuda Kinzoku Hakufun Kogyo; Sn—Cu—Ni—AtW-150) and 15% by volume of copper powder (produced by Fukuda Kinzoku Hakufun Kogyo; FCC-SP-77, mean particle diameter 10 μm) were lightly mixed together and fed into the kneader (Morlyama Seisakusho make, double-screw pressurized type) which was set at 220° C. The mixture was kneaded, without preheating time, at a rate ranging from 25 to 50 r.p.m. for 20 minutes while efforts were made to prevent the temperature of the kneaded material from rising to 235° C. or over, by lowering the rate of revolution, cooling, etc.; the resin was heat-plasticated and the solder, under half-melted condition, was dispersed throughout the resin. Observation, under an optical microscope, of the state of dispersion of the solder of the kneaded material showed that the solder was evenly dispersed throughout the resin and solder fractions were about 5 μm in size.

Embodiment 3

35% by volume of ABS resin (produced by Toray; Toyolac 441), 55% by volume of lead-free solder (produced by Fukuda Kinzoku Hakufun Kogyo; Sn—Cu—Ni—AtW-150) and 10% by volume of copper powder (produced by Fukuda Kinzoku Hakufun Kogyo; FCC-SP-77, mean particle diameter 10 μm) were lightly mixed together, and the total of the metal components was set at 65% by volume. Then the mixture was fed into the kneader (Moriyama Seisakusho make, double-screw pressurized type) which was set at 220° C. The mixture was kneaded, without preheating time, at a rate ranging from 25 to 50 r.p.m. for 20 minutes; the resin was heat-plasticated and the solder, under half-melted condition, was dispersed throughout the resin.

The kneaded material was pelletized by the plunger extrusion pelletizer (Toshin make, Model TP60-2) at the dies temperature ranging from 200 to 240° C. to produce pellets. These pellets were used to make injection molding into molds by the injection molding machine (Kawaguchi Tekko make, KS-10B). The preset temperature of the machine was from 230 to 280° C., and the mold temperature was from the ordinary temperature to 150° C. The injection moldings obtained showed no sign of segregation of metal, and their surfaces were even. Observation, under an optical microscope, of the state of dispersion of the solder showed that the solder was evenly dispersed throughout the resin and solder fractions were about 100 μm or under in size. The volume resistivity of this specimen was on the order of 4×10⁻⁵ Ω·cm.

As clearly shown by the above-mentioned specific examples, the lead-free solder could be dispersed finely throughout the resins, and even when a large volume of metal components as high as 65% by volume were mixed, a kneaded material that did not show any segregation, under heating, of metals from the resin was obtained successfully. As the solder fractions were continuous to each other in this lead-free ultrahigh-conductive plastic, the conductivity of the plastic did not show any deterioration even when the temperature changed, thus the plastic stably exhibited high conductivity. In injection molding, the plastic was successfully molded into fine configurations without any clogging.

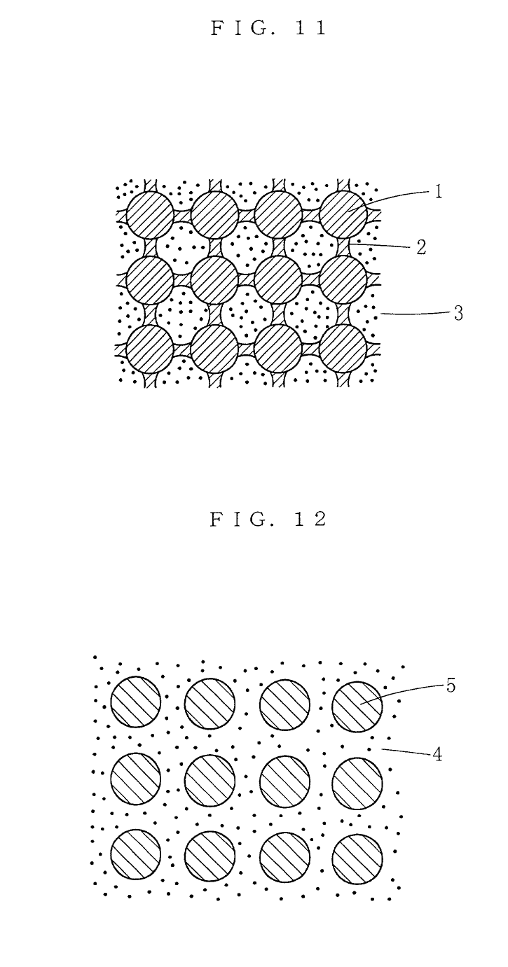

With the use of this lead-free ultrahigh-conductive plastic, electric contacts and the like having a three-dimensional configuration and low resistance can be formed by injection molding. In the following, with reference to the attached drawings, specific examples will be described in detail. FIG. 11 is a schematic structural diagram of the above-mentioned lead-free ultrahigh-conductive plastic. As shown in this diagram, in this lead-free ultrahigh-conductive plastic, the lead-free solders 1 are connected to each other by the solders 2 which are melted in the plastic 3. Hence the lead-free solders 1 are junctioned to each other and the conductivity is high and the reliability of the connection is high.

In contrast to this, as shown in FIG. 12, when powder 5 of a conventional metal that does not melt is kneaded in a plastic 4, the metal particles will not connect to each other unless a large amount of the metal content is mixed. Hence conductivity can not be obtained.

Thus the lead-free ultrahigh-conductive plastic shows a low resistance, does not exhibit deterioration in conductivity in a variety of environments, and has a high reliability.

To sum up, when a resin and a low-melting-point alloy (lead-free solder) which does not contain lead from the viewpoint of environment are used, and they are kneaded with the metal being kept in half-melted condition, the lead-free solder being the metal components can be dispersed finely throughout the resin. Moreover, as kneading is made when the lead-free solder is kept in half-melted condition, the dispersed solder fractions are kept connected continuously to each other. This connection is not just a contact but a junction between solder fractions. As the conductivity thus achieved differs from that obtained by contacts among metal fractions, even if the molding is heated to a high temperature, the junctions will not break, thus the molding stably exhibits low resistance.

When this material is to be formed by injection molding, as the metal components are partly half-melted and the lead-free solder is finely dispersed, the material can be formed by injection molding into fine configurations although the material contains a large amount of metal components. Hence electric contacts and the like can be formed by processes of injection molding alone. Moreover, as no plating is required, a conductive part of low resistance can be formed inside the frame (injection molding).

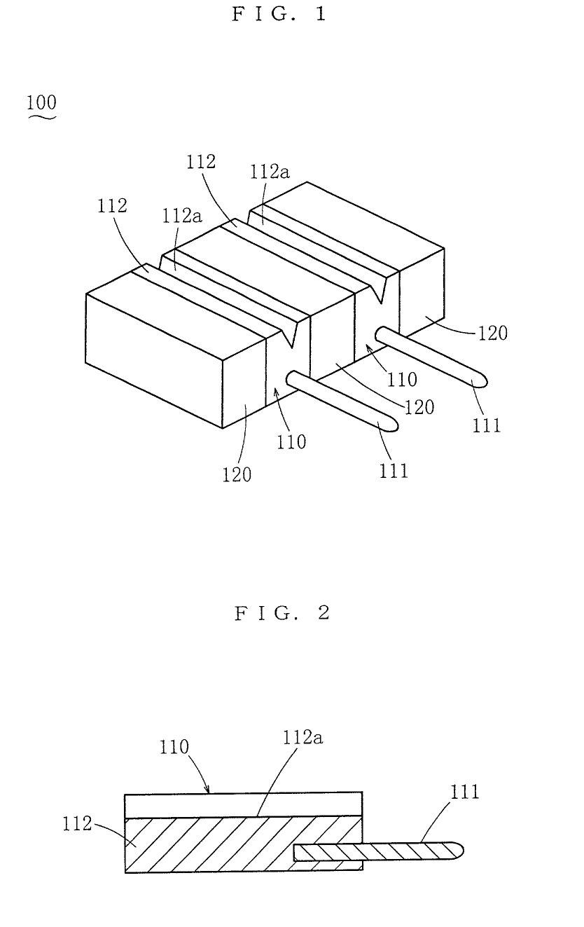

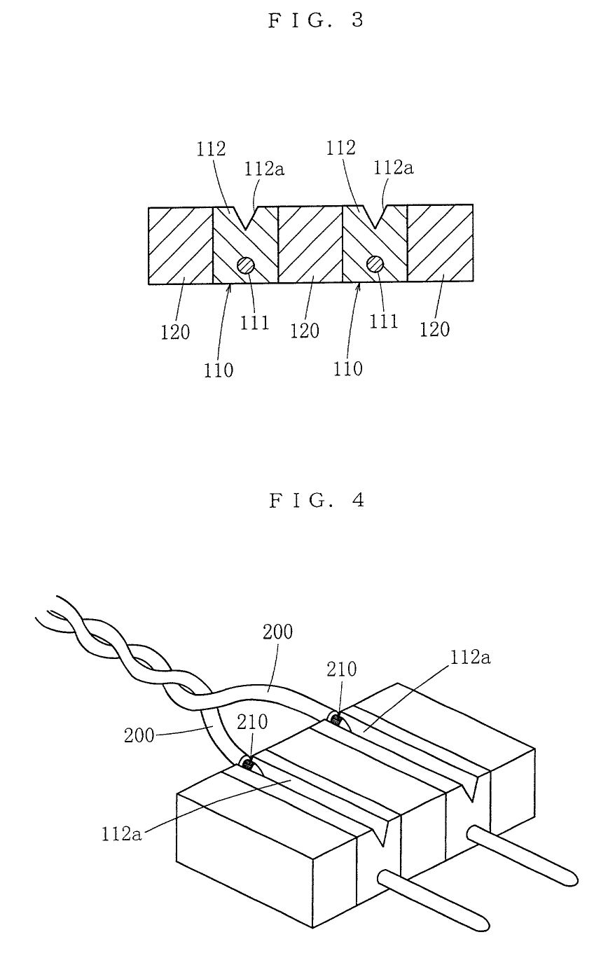

Next, the electric connectors for twisted pair cable using the resin solder of the embodiments of the present invention will be described. FIG. 1 through FIG. 3 show the electric connector 100 of the first embodiment. This electric connector 100 comprises a pair of electric contacts 110 having conductivity and an insulating member 120, which insulates and holds these electric contacts 110. In this embodiment, the insulating member 120 is arranged between one pair of the electric contacts 110, and this insulating member 120 is coupled with both the electric contacts 110. If such an insulating member is not used and a pair of electric contacts are held in an insulating housing, this insulating housing itself is the insulating member. The electric connector 100 of this embodiment may be held in an insulating housing. In this embodiment, an insulator member 120 is provided on the outer side of each electric contact 110, but they may not be used in some applications. The electric contact 110 is provided with a first connecting part 111, which fits with the counterpart connector, and a second connecting part 112, to which the conductor 210 of the electric wire 200 is connected. As the electric contact 110 of this embodiment is of the male type, such as pins, posts and tabs, the first connecting part 111 is such a protruding part. When the electric contact is of the female type, such as sockets and receptacles, the first connecting part is a tubular part which receives a protruding part of a male type electric contact and makes electric connection on the internal surface thereof. In this embodiment, the second connecting part 112 is formed into a rectangular parallelepiped approximately. The protruding part being the first connecting part 111 is made of a metal, for example, a copper alloy, and one end of the protruding part is coupled with an end of the second connecting part 112. The method of coupling the first connecting part 111 with the second connecting part 112 is, for example, casting, welding or adhesion. The insulating member 120 is made of an insulator, for example, a synthetic resin, and the insulating member 120 is located between the second connecting parts 112 of the electric contacts 110 to couple both the second connecting parts 112 to each other. The method of coupling the second connecting parts 112 with the insulating member 120 is, for example, simultaneous molding by multi-color injection molding or the like, welding or adhesion. Of the above-mentioned electric contact 110, at least a part of the second connecting part 112, to which the conductor 210 of the electric wire 200 is connected, is made of the lead-free ultrahigh-conductive plastic being the conductive resin composite. In that case, of the electric contact 110, the part of the second connecting part 112, to which the conductor 210 of the electric wire 200 is connected, may be made of the lead-free ultrahigh-conductive plastic, and other parts may be made of another material having conductivity, or the entirety may be made of the lead-free ultrahigh-conductive plastic. In this embodiment, the entirety of the second connecting part 112 is made of the lead-free ultrahigh-conductive plastic, and the first connecting part 111 is made of another material having conductivity, for example, a metal such as a copper alloy. Here, one pair of electric contacts 110 are used, but a plurality of pairs of electric contacts may be provided in one electric connector.

The second connecting part 112 is provided with a groove 112a which receives the conductor 210 of the electric wire 200. As shown in FIG. 1, this groove 112a may be formed to extend up to two free ends of the second connecting part 112, or it may be formed in only a part of the surface of the second connecting part 112.

Accordingly, as shown in FIG. 4, when the coverings of the ends of the electric wires 200 of the twisted pair cable are removed to expose the conductors 210, the conductors 210 are placed on the parts of the second connecting parts 112 of the electric contacts 110, to which the conductors 210 of the electric wires 200 are connected, and the contacting parts of them are heated, the lead-free solder being contained in the lead-free ultrahigh-conductive plastic of these parts will melt out to stick to the conductors 210 of the electric wires 200. When the lead-free solder cools and solidifies, the conductors 210 of the electric wires 200 will be connected to the electric contacts 110. The above-mentioned heating is effected by, for example, blowing hot air or irradiating high frequency waves or laser beams to give thermal energy. This work can be done without undoing the twist at the end of the twisted pair cable. Hence the twist of the twisted pair cable can be maintained properly up to the end, the noise signal cancellation effect can be exhibited to the full, and the impedance matching can be maximized. Moreover, as the work of undoing the twist at the end of the twisted pair cable and retwisting the end thereof is not required, the connecting work can be done easily. Furthermore, the work of separately applying solder is not required. Hence an electric wire can be easily connected to a part which it is difficult or impossible to solder, for example, a recess in the electric contact 110. Moreover, as solder quality control, temperature control and the like are not required, the control man-hour is reduced correspondingly. Further, the connection of a very fine wire can be done by an automatic machine, and the productivity is enhanced and the cost is reduced. The lead-free ultrahigh-conductive plastic exhibits high conductivity, as high as 10⁻³ Ω·cm or under in volume resistivity. Hence the electric resistance of the electric contact 110 can be reduced. After the connection of the electric wires 200, when electricity is passed at a normal level, the lead-free ultrahigh-conductive plastic will not melt due to heat generation. Moreover, in comparison with the technology of MID wherein a conductive plated layer is formed on the surface of an insulator, the lead-free ultrahigh-conductive plastic provides the conductor with a larger cross-sectional area and a larger volume. Hence the resistance of the conductor can be reduced and the heat dissipation is better. This in turn allows passage of a larger current. As the lead-free ultrahigh-conductive plastic can be formed by injection molding, it gives a higher degree of freedom in molding. Hence parts to be made of the lead-free ultrahigh-conductive plastic can be formed into a variety of configurations according to applications. This makes it easier to obtain impedance matching.

Like the first embodiment, when only a part of the electric contact 110 is made of the lead-free ultrahigh-conductive plastic, if the other parts are made of a material of which strength and elasticity are greater than those of the lead-free ultrahigh-conductive plastic, for example, a metal, the strength and elasticity of the electric contact 110, and in particular, the strength and elasticity of the first connecting part 111 will be improved. In that case, the electric contact 111 may be produced by insert molding, which is a kind of injection molding.

The present invention includes all embodiments wherein the second connecting part has a part to which the conductor of an electric wire is connected. Accordingly, the present invention includes the electric connector 100 of the second embodiment as shown in FIG. 6. This electric connector 100 differs from the electric connector 100 of the first embodiment in that the surface of the second connecting part 112 is a simple flat or curved surface. The second embodiment is similar to the first embodiment in other aspects. In this case, the conductor 210 of the electric wire 200 is connected to the surface of the second connecting part 112. In contrast to the second embodiment, the second connecting part 112 of the first embodiment has a groove 112a which receives the conductor 210 of the electric wire 200. When the conductor 210 of the electric wire 200 is received by the groove 112a of the second connecting part 112, the electric wire 200 will be tacked onto the electric contact 110. When the groove 112a is heated and then cooled, the conductor 210 of the electric wire 200 will be connected to the electric contact 110, and in turn the electric wire 200 and the electric contact 110 will be connected to each other. Hence the work of connecting the electric wire 200 to the electric contact 110 can be done easily.

The present invention does not limit the material of the insulating member and the method of producing the electric connector. Among embodiments according to the present invention, in the first embodiment, the insulating member 120 is made of a synthetic resin, and the part of the electric contact 110, which is made of the lead-free ultrahigh-conductive plastic, and the insulating member 120 are produced by multi-color injection molding. When multi-color injection molding is used in such a manner, at least the essential parts of the electric connector 100 can be formed at a stroke, and the productivity is high. The synthetic resin to be used for this insulating member 120 is not limited specifically, and those that have been used conventionally can be used. However, from the viewpoints of ease in molding and some other physical properties required, it is preferable to use a thermoplastic resin.

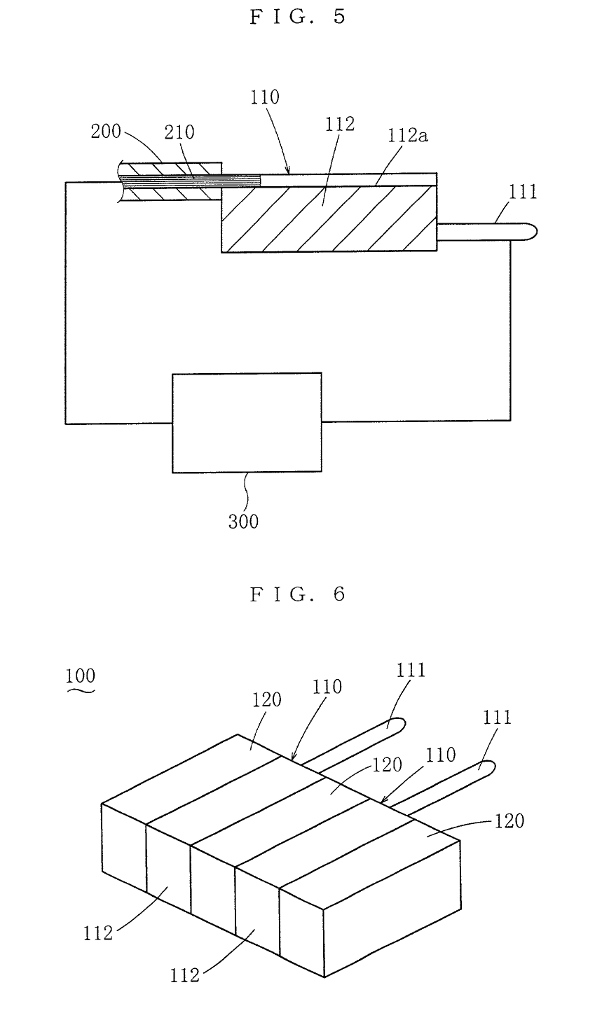

Another embodiment of the method of connecting the electric wire 200 to this electric connector 100 will be described. As shown in FIG. 5, first the conductor 210 of the electric wire 200 is placed on the second connecting part 112 of the electric contact 110. Next, electricity is passed between the electric contact 110 and the conductor 210 of the electric wire 200 by a power source 300 to melt the lead-free solder which is contained in the second connecting part 112 and connect the conductor 210 of the electric wire 200 to the electric contact 110.

When this method is used, as the second connecting part 112 generates heat by itself, even if it is difficult to externally heat the contacting parts of both the second connecting part 112 and the conductor 210 of the electric wire 200, the conductor 210 of the electric wire 200 can be connected to the electric contact 110.

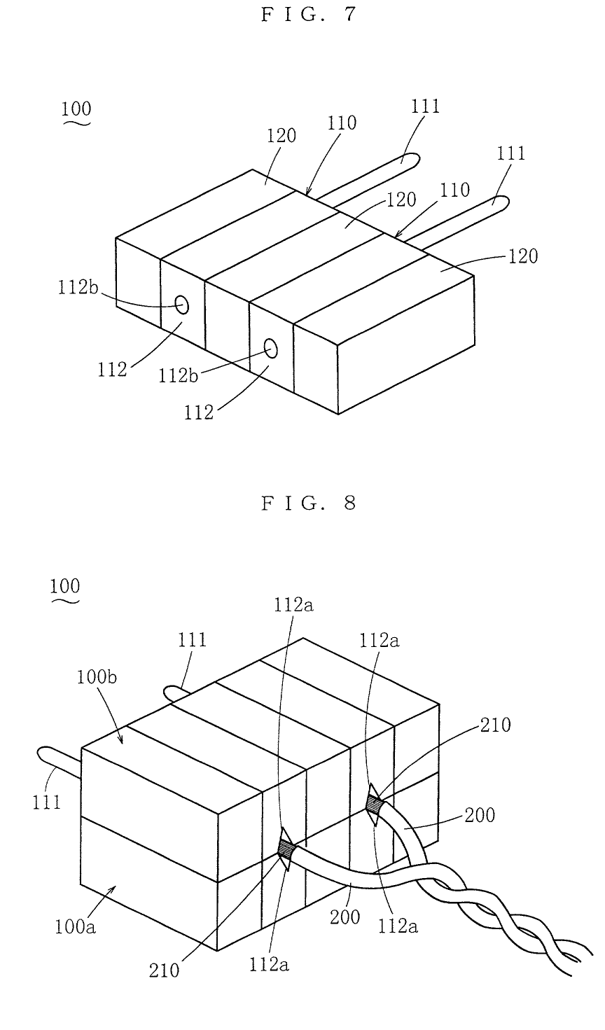

FIG. 7 shows the electric connector 100 of the third embodiment. This electric connector 100 differs from the electric connector 100 of the first embodiment in that the second connecting part 112 has a hole 112b into which the conductor 210 of the electric wire 200 is inserted, instead of the groove 112a. The third embodiment is similar to the first embodiment in other aspects. With this arrangement, when the conductor 210 of the electric wire 200 is inserted into the hole 112b of the second connecting part 112, the electric wire 200 will be tacked to the electric contact 110. When the hole 112b is heated and then cooled, the conductor 210 of the electric wire 200 will be connected to the electric contact 110, and the electric wire 200 and the electric contact 110 will be connected to each other. Hence the work of connecting the electric wire 200 to the electric contact 110 can be done easily.

FIG. 8 shows the electric connector 100 of the fourth embodiment. This electric connector 100 is halved into a lower connector 100a and an upper connector 100b. The lower connector 100a is identical to the electric connector 100 of the first embodiment. The upper connector 100b is the electric connector 100 of the first embodiment from which the first connecting parts 111 are eliminated. The conductor 210 of each electric wire 200 is held between the grooves 112a of both the connectors 100a, 100b. The conductor 210 is connected to the second connecting part 112 by the lead-free solder which is contained in the lead-free ultrahigh-conductive plastic of the second connecting part 112. The covering of the end of the electric wire 200 of the twisted pair cable is removed to expose the conductor 210, this conductor 210 is placed on the part of the second connecting part 112 of the electric contact 110 of the lower connector 100a, to which the conductor 210 of the electric wire 200 is to be connected, and the upper connector b is placed in such a way that the groove 112a of the connector 100a and the groove 112a of the connector 100b oppose to each other. When the contacting parts of the conductor 210 of the electric wire 200 and the grooves 112a are heated, the lead-free solder being contained in the lead-free ultrahigh-conductive plastic will melt out to stick to the conductor 210 of the electric wire 200. When the lead-free solder cools and solidifies, the conductor 210 of the electric wire 200 will be connected to the electric contact 110. Accordingly, the functions and effects obtained by this embodiment are similar to those of the first embodiment, but this embodiment has a merit that the tacking can be done more reliably because the conductor 210 of the electric wire 200 is sandwiched between two connectors 100a, 100b.

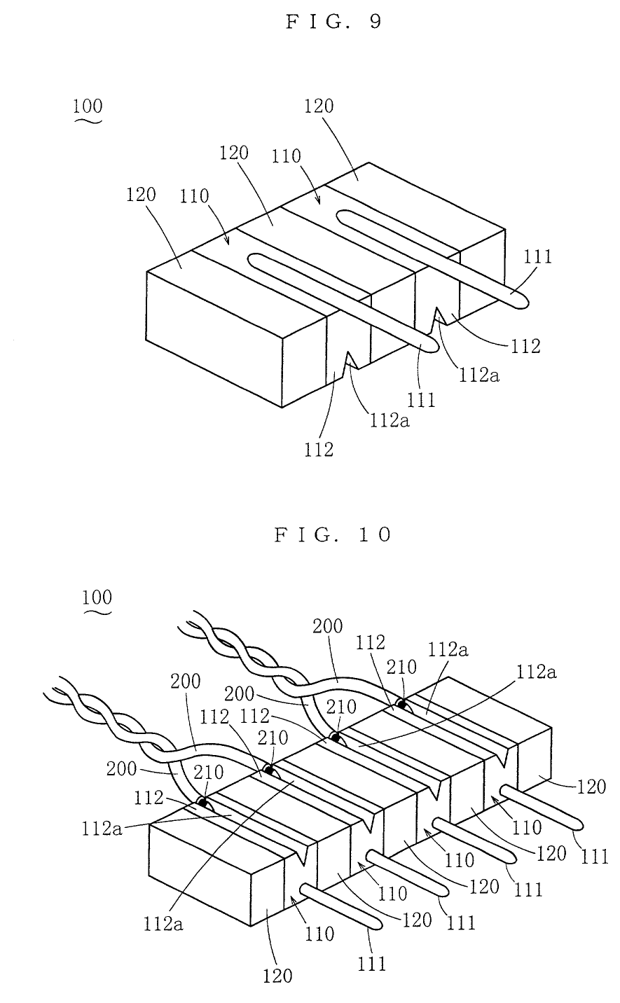

FIG. 9 shows the electric connector 100 of the fifth embodiment. In the electric connector 100 of the first embodiment, the protruding part being the first connecting part 111 is coupled to the second connecting part 112 to protrude from the surface of the second connecting part 112. In contrast to it, in the electric connector 100 of the fifth embodiment, the circumferential face of one end of the protruding part being the first connecting part 111 is coupled with the surface of the second connecting part 112. Other constructions are similar to those of the electric connector 100 of the first embodiment. Accordingly, the functions and effects of the fifth embodiment are similar to those of the first embodiment, but it is easier to couple the protruding part being the first connecting part 111 to the second connecting part 112 when this coupling is done as a separate process by, for example, casting, welding or adhesion.

FIG. 10 shows the electric connector 100 of the sixth embodiment. One pair of electric contacts 110 are used in the electric connector 100 of the first embodiment, whereas two pairs of electric contacts 110 are used in the electric connector 100 of the sixth embodiment. In both the first and sixth embodiments, one insulating member 120 is placed between two adjacent second connecting parts 112 of the electric contacts 110 to couple both the second connecting parts 112 to each other. With this arrangement, as shown in FIG. 10, two twisted pair cables can be connected.

Next, the electric connector 100 of the seventh embodiment will be described. As exemplified by the electric connectors 100 of the respective embodiments described above, in this electric connector 100, the first connecting part 111 is a protruding part, and the second connecting part 112 has a face onto which the conductor 210 of the electric wire 200 contacts, a hole 112b into which the conductor 210 of the electric wire 200 is inserted, or a groove 112a which receives the conductor 210 of the electric wire 200. The seventh embodiment differs from the above-mentioned embodiments in that the entirety of each electric contact 110 is made of the lead-free ultrahigh-conductive plastic.

With this arrangement, when the conductor 210 of the electric wire 200 is inserted into the hole 112b of the second connecting part 112 or received by the groove 112a, the electric wire 200 will be tacked on the electric contact 110. When the hole 112b or the groove 112a is heated and then cooled, the conductor 210 of the electric wire 200 will be connected to the electric contact 110, and both the electric wire 200 and the electric contact 110 will be connected together. In this case, as the first connecting part 111 and the second connecting part 112 are free of any part which is subjected to a large bending force or the like, no measures will be needed to improve the elasticity by designing the configurations of the respective connecting parts 111, 112. Thus designing of the configuration is simple.

In that case, the first connecting part 111 may be simply made of the lead-free ultrahigh-conductive plastic, but if a plated layer for increasing the hardness is formed on the surface of the first connecting part 111, the surface hardness of the first connecting part 111 will be increased, and even if it is subjected to frictional forces, for example, by repeated insertion and extraction, the wear will be restrained. Thus the durability will be improved.

The present invention includes all embodiments wherein features of the embodiments described above are combined.

With the description of these embodiments, the first electric connector for twisted pair cable using resin solder, which was described in the summary of the invention, has been fully disclosed. Moreover, with the description of these embodiments, the second through fifth electric connectors for twisted pair cable using resin solder and the method of connecting electric wire to these electric connectors, which will be described below, have been fully explained.

The second electric connector for twisted pair cable using resin solder is the above-mentioned first electric connector for twisted pair cable using resin solder, wherein the second connecting part has a hole into which the conductor of the electric wire is inserted or a groove on which the conductor of the electric wire is received.

With this arrangement, when the conductor of the electric wire is inserted into the hole of the second connecting part or received on the groove of the second connecting part, the electric wire will be tacked on the electric contact. When the hole or the groove is heated and then cooled, the conductor of the electric wire will be connected to the electric contact, and the electric wire and the electric contact will be connected to each other. Thus the work of connecting the electric wire to the electric contact can be done easily.

The third electric connector for twisted pair cable using resin solder is the above-mentioned first electric connector for twisted pair cable using resin solder, wherein the first connecting part is a protruding part, the second connecting part has a face which the conductor of the electric wire contacts, a hole into which the conductor of the electric wire is inserted, or a groove on which the conductor of the electric wire is received, and the entirety of the electric contact is made of the lead-free ultrahigh-conductive plastic.

With this arrangement, when the conductor of the electric wire is inserted into the hole of the second connecting part or received on the groove, the electric wire will be tacked on the electric contact. When the hole or the groove is heated and cooled, the conductor of the electric wire will be connected to the electric contact, and the electric wire and the electric contact will be connected to each other. Hence the work of connecting the electric wire to the electric contact can be done easily. In this case, as the first connecting part and the second connecting part are free of any part which is subjected to a large bending force or the like, no measures will be needed to improve the elasticity by designing the configurations of the respective connecting parts. Thus designing of the configuration is simple.

The fourth electric connector for twisted pair cable using resin solder is the above-mentioned third electric connector for twisted pair cable using resin solder, wherein a plated layer for increasing the hardness is formed on the surface of the first connecting part.

With this arrangement, the surface hardness of the first connecting part is increased, and even if it is subjected to frictional forces, for example, by repeated insertion and extraction, the wear will be restrained. Thus the durability will be improved.

The fifth electric connector for twisted pair cable using resin solder is any one of the above-mentioned first through fourth electric connectors for twisted pair cable using resin solder, wherein the insulating member is made of a synthetic resin, and the part of the electric contact which is made of the lead-free ultrahigh-conductive plastic and the insulating member are formed by multi-color injection molding.

With this arrangement, the part of the electric contact which is made of the lead-free ultrahigh-conductive plastic and the insulating member can be formed at a stroke by multi-color injection molding.

The method of connecting the electric wire to any one of the above-mentioned first through fifth electric connectors for twisted pair cable using resin solder comprises placing the conductor of the electric wire on the second connecting part of the electric contact and passing electricity between the electric contact and the conductor of the electric wire to melt the lead-free solder being contained in the second connecting part and connect the conductor of the electric wire to the electric contact.

When this method of connecting electric wire is used, as the second connecting part generates heat by itself, even if it is difficult to externally heat the contacting parts of the second connecting part and the conductor of the electric wire, the conductor of the electric wire will be connected to the electric contact.

What is claimed is:

1. An electric connector for twisted pair cable using resin solder,
the electric connector comprising
a pair of electric contacts having a first connecting part, which fits with a counterpart connector, and a second connecting part, to which a conductor of an electric wire is connected, and
an insulating member, which insulates and holds these electric contacts, and
in each of the electric contacts, at least a part of the second connecting part, to which the conductor of the electric wire is connected, is made of a lead-free ultrahigh-conductive plastic being a conductive resin composite, comprising a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal.

2. An electric connector for twisted pair cable using resin solder as recited in claim 1, wherein
the second connecting part has a hole into which the conductor of the electric wire is inserted or a groove on which the conductor of the electric wire is received.

3. An electric connector for twisted pair cable using resin solder as recited in claim 1, wherein
the first connecting part is a protruding part, the second connecting part has a face which the conductor of the electric wire contacts, a hole into which the conductor of the electric wire is inserted, or a groove on which the conductor of the electric wire is received, and
the entirety of the electric contact is made of the lead-free ultrahigh-conductive plastic.

4. An electric connector for twisted pair cable using resin solder as recited in claim 3, wherein
a plated layer for increasing the hardness is formed on the surface of the first connecting part.

5. An electric connector for twisted pair cable using resin solder as recited in claim 1, wherein
the insulating member is made of a synthetic resin, and
the part of the electric contact which is made of the lead-free ultrahigh-conductive plastic and the insulating member are formed by multi-color injection molding.

6. An electric connector for twisted pair cable using resin solder as recited in claim 2, wherein
the insulating member is made of a synthetic resin, and
the part of the electric contact which is made of the lead-free ultrahigh-conductive plastic and the insulating member are formed by multi-color injection molding.

7. An electric connector for twisted pair cable using resin solder as recited in claim 3, wherein
the insulating member is made of a synthetic resin, and
the part of the electric contact which is made of the lead-free ultrahigh-conductive plastic and the insulating member are formed by multi-color injection molding.

8. An electric connector for twisted pair cable using resin solder as recited in claim 4, wherein
the insulating member is made of a synthetic resin, and
the part of the electric contact which is made of the lead-free ultrahigh-conductive plastic and the insulating member are formed by multi-color injection molding.

9. A method of connecting electric wire to the electric connector for twisted pair cable using resin solder of claim 1 comprising
placing the conductor of the electric wire on the second connecting part of the electric contact and passing electricity between the electric contact and the conductor of the electric wire to melt the lead-free solder being contained in the second connecting part and connect the conductor of the electric wire to the electric contact.

10. A method of connecting electric wire to the electric connector for twisted pair cable using resin solder of claim 2 comprising
placing the conductor of the electric wire on the second connecting part of the electric contact and passing electricity between the electric contact and the conductor of the electric wire to melt the lead-free solder being contained in the second connecting part and connect the conductor of the electric wire to the electric contact.

11. A method of connecting electric wire to the electric connector for twisted pair cable using resin solder of claim 3 comprising
placing the conductor of the electric wire on the second connecting part of the electric contact and passing electricity between the electric contact and the conductor of the electric wire to melt the lead-free solder being contained in the second connecting part and connect the conductor of the electric wire to the electric contact.

12. A method of connecting electric wire to the electric connector for twisted pair cable using resin solder of claim 4 comprising
placing the conductor of the electric wire on the second connecting part of the electric contact and passing electricity between the electric contact and the conductor of the electric wire to melt the lead-free solder being contained in the second connecting part and connect the conductor of the electric wire to the electric contact.

13. A method of connecting electric wire to the electric connector for twisted pair cable using resin solder of claim 5 comprising
placing the conductor of the electric wire on the second connecting part of the electric contact and passing electricity between the electric contact and the conductor of the electric wire to melt the lead-free solder being contained in the second connecting part and connect the conductor of the electric wire to the electric contact.

14. A method of connecting electric wire to the electric connector for twisted pair cable using resin solder of claim 6 comprising
placing the conductor of the electric wire on the second connecting part of the electric contact and passing electricity between the electric contact and the conductor of the electric wire to melt the lead-free solder being contained in the second connecting part and connect the conductor of the electric wire to the electric contact.

15. A method of connecting electric wire to the electric connector for twisted pair cable using resin solder of claim 7 comprising
placing the conductor of the electric wire on the second connecting part of the electric contact and passing electricity between the electric contact and the conductor of the electric wire to melt the lead-free solder being contained in the second connecting part and connect the conductor of the electric wire to the electric contact.

16. A method of connecting electric wire to the electric connector for twisted pair cable using resin solder of claim 8 comprising
placing the conductor of the electric wire on the second connecting part of the electric contact and passing electricity between the electric contact and the conductor of the electric wire to melt the lead-free solder being contained in the second connecting part and connect the conductor of the electric wire to the electric contact.
